(19) United States
(12) Patent Application Publication
(10) Pub. No.: US 2025/0297099 A1
(43) Pub. Date: Sep. 25, 2025

(54) Polymer Composition Containing a Blend of Liquid Crystalline Polymers

(71) Applicant: Ticona LLC, Florence, KY (US)

(72) Inventor: Young Shin Kim, Cincinnati, OH (US)

(21) Appl. No.: 19/062,101

(22) Filed: Feb. 25, 2025

Related U.S. Application Data
(60) Provisional application No. 63/567,600, filed on Mar. 20, 2024.

(51) Int. Cl. C08L 67/04

(52) U.S. Cl. CPC C08L 67/04; C08L 2205/025; C08L 2205/03; C08L 2205/12; C08L 2207/20

(57) ABSTRACT

A polymer composition that contains a polymer matrix is provided. The polymer matrix includes a blend of one or more first liquid crystalline polymers and one or more second liquid crystalline polymers. Through careful control over the specific nature and concentration of the polymers, the present inventor has discovered that the polymers can be melt compounded together without the mechanism of transesterification leading to a substantial degradation in the thermal and mechanical properties of the resulting composition.

### RELATED APPLICATION

The present application is based upon and claims priority to U.S. Provisional Patent Application Ser. No. 63/567,600, having a filing date of Mar. 20, 2024, which is incorporated herein by reference.

### BACKGROUND OF THE INVENTION

Liquid crystalline polymers are polyesters that are used in a wide variety of high performance applications, such as in high voltage connectors, medical products, camera modules, and so forth. The polymers are generally formed by acetylating aromatic monomers (e.g., with acetic anhydride) and then heating the acetylated monomers within a reactor until a target molecular weight is achieved. Following polymerization, the molten polymer may be discharged from the reactor, cooled, and collected. Commonly, the melt is discharged through a perforated die to form strands that are taken up in a water bath, pelletized and dried. The resulting polymer may then be compounded with other polymers and/or fillers. Unfortunately, during the process of synthesizing liquid crystalline polymers and/or compounding them with other materials, a significant portion of the resulting polymer may be discarded as waste “scrap”, which may include flakes, fluff, fines, fibers, etc. that are not able to be formed into commercially suitable pellets during the production process. Ideally, it would be desirable to recycle the scrap in blends with other liquid crystalline polymers, such as in a blend with virgin or other recycled liquid crystalline polymers. However, the ability to recycle the scrap in this manner is difficult to achieve due to the tendency of polyester blends to undergo transesterification during processing, resulting in molecular rearrangements, transient properties, and eventually, degradation. As such, a need exists for a polymer composition that includes a blend of different liquid crystalline polymers in which one or more of the polymers can be derived from scrap.

### SUMMARY OF THE INVENTION

In accordance with one embodiment of the present invention, a polymer composition is disclosed that comprises comprising a polymer matrix. The polymer matrix comprises at least one first liquid crystalline polymer containing aromatic dicarboxylic acid repeating units derived from 2,6-naphthalenedicarboxylic acid and optionally terephthalic acid, isophthalic acid, or a combination thereof; aromatic diol repeating units derived from hydroquinone, 4,4′-biphenol, or a combination thereof; and aromatic hydroxycarboxylic acid repeating units derived from 4-hydroxybenzoic acid, 6-hydroxy-2-naphthoic acid, or a combination thereof, wherein the repeating units derived from 2,6-naphthalenedicarboxylic acid constitute from about 2 mol. % to about 30 mol. % of the first liquid crystalline polymer. The polymer matrix further comprises at least one second liquid crystalline polymer containing aromatic dicarboxylic acid repeating units derived from 2,6-naphthalenedicarboxylic acid, terephthalic acid, isophthalic acid, or a combination thereof; aromatic diol repeating units derived from hydroquinone, 4,4′-biphenol, or a combination thereof; and aromatic hydroxycarboxylic acid repeating units derived from 4-hydroxybenzoic acid, 6-hydroxy-2-naphthoic acid, or a combination thereof, wherein the repeating units derived from 2,6-naphthalenedicarboxylic acid constitute no more than about 0.5 mol. % of the second liquid crystalline polymer. The ratio of the aromatic diol repeating units of the first liquid crystalline polymer to the aromatic diol repeating units of the second liquid crystalline polymer is from about 1 to about 8.

Other features and aspects of the present invention are set forth in greater detail below.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition that contains a polymer matrix. The polymer matrix includes a blend of one or more first liquid crystalline polymers and one or more second liquid crystalline polymers. Through careful control over the specific nature of the polymers, the present inventor has discovered that the polymers can be melt compounded together without the mechanism of transesterification leading to a substantial degradation in the thermal and mechanical properties of the resulting composition.

The polymer composition may, for example, exhibit a high melting temperature, such as about 240° C. or more, in some embodiments about 260° C. or more, in some embodiments about 290° C. or more, in some embodiments from about 300° C. to about 400° C., in some embodiments from about 310° C. to about 380° C., and in some embodiments, from about 320° C. to about 370° C. Even at such melting temperatures, the ratio of the deflection temperature under load (“DTUL”), a measure of short term heat resistance, to the melting temperature may still remain relatively high. For example, the ratio may range from about 0.5 to about 1.00, in some embodiments from about 0.6 to about 0.95, and in some embodiments, from about 0.65 to about 0.85. The specific DTUL values may, for instance, be about 150° C. or more, in some embodiments about 200° C. or more, in some embodiments about 240° C. or more, in some embodiments about 245° C. or more, in some embodiments about 250° C. or more, and in some embodiments, from about 255° C. to about 300° C. Such high DTUL values can, among other things, allow the use of high speed and reliable surface mounting processes for mating a molded part formed from the polymer composition with other components. The heat resistance of the polymer composition may also be reflected by the “blister-free temperature”, as described in more detail below, which may be about 240° C. or more, in some embodiments about 250° C. or more, in some embodiments from about 260° C. to about 300° C., and in some embodiments, from about 270° C. to about 290° C.

Besides good thermal properties, the polymer composition may nevertheless still exhibit excellent mechanical properties. For example, the composition may exhibit a relatively high tensile and/or flexural modulus, which allows it to remain relatively stiff once molded into a thin part. The tensile modulus may, for instance, be about 10,000 MPa or more, in some embodiments about 8,000 MPa or more, in some embodiments from about 12,000 MPa to about 25,000 MPa, and in some embodiments, from about 14,000 MPa to about 20,000 MPa as determined in accordance with ISO 527:2019 at a temperature of 23° C. The flexural modulus may likewise be about 10,000 MPa or more, in some embodiments about 8,000 MPa or more, in some embodiments from about 12,000 MPa to about 25,000 MPa, and in some embodiments, from about 14,000 MPa to about 20,000 MPa as determined in accordance with ISO 178:2019 at a temperature of 23° C. Of course, the polymer composition may also exhibit other good tensile and flexural properties. For example, the polymer composition may exhibit a tensile strength of about 10 MPa or more, in some embodiments from about 120 MPa to about 250 MPa, and in some embodiments, from about 120 MPa to about 180 MPa and/or a tensile elongation of about 0.5% or more, in some embodiments from about 0.6% to about 3.5%, and in some embodiments, from about 0.8% to about 3%, as determined in accordance with ISO 527:2019 at a temperature of 23° C. The polymer composition may also exhibit a flexural strength of about 100 MPa or more, in some embodiments from about 150 MPa to about 350 MPa, and in some embodiments, from about 180 MPa to about 250 MPa and/or a flexural elongation of about 0.5% or more, in some embodiments from about 0.6% to about 3.5%, and in some embodiments, from about 0.8% to about 3%, as determined in accordance with ISO 178:2019 at a temperature of 23° C. The impact strength may also be good. For example, the composition may exhibit a Charpy notched impact strength of about 3 KJ/m² or more, in some embodiments from about 5 to about 20 KJ/m², and in some embodiments, from about 8 to about 15 KJ/m², measured at 23° C. according to ISO 179-1:2010.

In addition to the properties noted above, the polymer composition may also be generally flame retardant, even at relatively small thickness values, such as about 4 millimeters or less, in some embodiments about from about 0.2 to about 3.2 millimeters, in some embodiments from about 0.4 to about 2.5 millimeters, and in some embodiments, from about 0.8 to about 2 millimeters. The flame retardant properties of the composition may be characterized in accordance with the vertical burn test procedure of UL94 of the “Tests for Flammability of Plastic Materials for Parts in Devices and Appliances” (edition date of Feb. 28, 2023). According to this procedure, for example, the composition may exhibit a V-0 rating at a part thickness of about 0.8 millimeters, as well as even smaller thicknesses, such as about 0.4 or about 0.2 millimeters. To achieve a V-0 rating, for example, the polymer composition generally exhibits no drips that ignite the cotton batting. However, the polymer composition may even exhibit less than 3 drips, in some embodiments less than 2 drips, in some embodiments less than 1 drip (e.g., 0 drips) that do not ignite the cotton batting. The polymer composition may also exhibit a total flame time (t1+t2) of about 50 seconds or less, in some embodiments about 40 seconds or less, in some embodiments about 30 seconds or less, and in some embodiments, about 20 seconds or less. The polymer composition may exhibit a V-O rating before aging (“unaged V-0 rating”) and/or after aging at a temperature of 70° C. for 7 days (“aged V-0 rating”).

The polymer composition may also have a relatively smooth surface, such as characterized by a high Rockwell surface hardness of about 25 or more, in some embodiments about 35 or more, in some embodiments about 45 or more, and in some embodiments, from about 55 to about 100, as determined in accordance with ASTM D785-08 (2015) (Scale M).

Besides having the good physical and thermal characteristics noted above, the polymers composition may still exhibit a low melt viscosity, which can enable its use in certain types of ultrathin electronic components. For example, the polymer composition may have a melt viscosity of about 100 Pa-s or less, in some embodiments from about 1 to about 80 Pa-s, and in some embodiments, from about 5 about 60 Pa-s, as determined at a shear rate of 1,000 seconds⁻¹ in accordance with ISO 11443:2021 at a temperature that is 15° C. higher than the melting temperature of the composition (e.g., about 360° C. for a melting temperature of about 345° C.).

Various embodiments of the present invention will now be described in more detail.

### I. Polymer Matrix

### A. First Liquid Crystalline Polymers

As noted above, the polymer matrix contains one or more first liquid crystalline polymers, typically in an amount from about 1 wt. % to about 50 wt. %, in some embodiments from about 2 wt. % to about 45 wt. %, and in some embodiments, from about 5 wt. % to about 40 wt. % of the polymer matrix and from about 1 wt. % to about 20 wt. %, in some embodiments from about 2 wt. % to about 15 wt. %, and in some embodiments, from about 3 wt. % to about 12 wt. % of the polymer composition. The first liquid crystalline polymer(s) may have a relatively high melting temperature, such as about 300° C. or more, in some embodiments from about 310° C. to about 400° C., in some embodiments from about 320° C. to about 380° C., and in some embodiments, from about 330° C. to about 370° C.

The first liquid crystalline polymer(s) may contain aromatic dicarboxylic acid repeating units derived from one or more aromatic dicarboxylic acids; (ii) aromatic diol repeating units derived from one or more aromatic diols, and (iii) aromatic hydroxycarboxylic acid repeating units derived from one or more aromatic hydroxycarboxylic acids. The aromatic dicarboxylic acid(s) generally include 2,6-naphthalenedicarboxylic acid (“NDA”) and may optionally include one or more other suitable aromatic dicarboxylic acids such as, terephthalic acid (“TA”), isophthalic acid (“IA”), diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl) ether, bis(4-carboxyphenyl) butane, bis(4-carboxyphenyl) ethane, bis(3-carboxyphenyl) ether, bis(3-carboxyphenyl) ethane, etc., as well as alkyl, alkoxy, aryl and halogen substituents thereof, and combinations thereof. The aromatic diols may include hydroquinone (“HQ”), 4,4′-biphenol (“BP”), resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl) ethane, etc., as well as alkyl, alkoxy, aryl and halogen substituents thereof, and combinations thereof. The aromatic hydroxycarboxylic acid(s) may include 4-hydroxybenzoic acid (“HBA”), 6-hydroxy-2-naphthoic acid (“HNA”), 4-hydroxy-4′-biphenylcarboxylic acid, 2-hydroxy-6-naphthoic acid, 2-hydroxy-5-naphthoic acid, 3-hydroxy-2-naphthoic acid, 2-hydroxy-3-naphthoic acid, 4′-hydroxyphenyl-4-benzoic acid, 3′-hydroxyphenyl-4-benzoic acid, 4′-hydroxyphenyl-3-benzoic acid, etc., as well as alkyl, alkoxy, aryl and halogen substituents thereof, and combination thereof.

The relative amounts of the monomeric constituents of the first liquid crystalline polymer(s) can be selectively controlled to help achieve the desired properties. In one embodiment, for instance, the first liquid crystalline polymer(s) may contain repeating units derived from NDA in an amount of from about 2 mol. % to about 30 mol. %, in some embodiments from about 3 mol. % to about 25 mol. %, and in some embodiments, from about 4 mol. % to about 22 mol. %. In addition to NDA, the first liquid crystalline polymer(s) may also contain other repeating units derived from aromatic dicarboxylic acids as noted above. For example, in certain embodiments, the first liquid crystalline polymer(s) may contain repeating units derived from TA and/or IA, which in total, may constitute from about 1 mol. % to about 30 mol. %, in some embodiments from about 2 mol. % to about 25 mol. %, and in some embodiments, from about 5 mol. % to about 20 mol. % of the polymer. The first liquid crystalline polymer(s) may also contain repeating units derived from HQ and/or BP, which in total, may constitute from about 5 mol. % to about 40 mol. %., in some embodiments from about 10 mol. % to about 35 mol. %, and in some embodiments, from about 15 mol. % to about 30 mol. % of the polymer. In addition to the components noted above, the first liquid crystalline polymer(s) may contain repeating units derived from HBA, which may constitute from about 30 mol. % to about 80 mol. %, and in some embodiments from about 35 mol. % to about 75 mol. %, and in some embodiments, from about 40 mol. % to about 70 mol. %. When employed, the molar ratio of HBA to NDA may be selectively controlled within a specific range to help achieve the desired properties, such as from about 0.5 to about 20, in some embodiments from about 0.6 to about 18, and in some embodiments, from about 1 to about 15. Likewise, the total amount of NDA, TA and IA may be equimolar or in molar excess relative to the total amount of HQ and BP to help achieve the desired properties. In other words, the ratio of the moles of NDA, TA, and/or IA to the moles of HQ and/or BQ may be about 1 or more, in some embodiments from about 1 to about 1.5, and in some embodiments, from about 1.001 to about 1.3.

Of course, other monomer components may also be employed in the first liquid crystalline polymer(s), such as those derived from one or more aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments, from about 1 mol. % to about 10 mol. % of the polymer. It should also be understood that various other monomeric repeating units may be incorporated into the polymer. For instance, in certain embodiments, the polymer(s) may contain one or more repeating units derived from non-aromatic monomers, such as aliphatic or cycloaliphatic hydroxycarboxylic acids, dicarboxylic acids, diols, amides, amines, etc. Of course, in other embodiments, the polymer(s) may be “wholly aromatic” in that it lacks repeating units derived from non-aromatic (e.g., aliphatic or cycloaliphatic) monomers.

### B. Second Liquid Crystalline Polymers

The polymer matrix also contains one or more second liquid crystalline polymer, typically in an amount from about 50 wt. % to about 99 wt. %, in some embodiments from about 55 wt. % to about 98 wt. %, and in some embodiments, from about 60 wt. % to about 95 wt. % of the polymer matrix and from about 20 wt. % to about 70 wt. %, in some embodiments from about 25 wt. % to about 65 wt. %, and in some embodiments, from about 30 wt. % to about 60 wt. % of the polymer composition. The second liquid crystalline polymer(s) may have a relatively high melting temperature, such as about 300° C. or more, in some embodiments from about 310° C. to about 400° C., in some embodiments from about 320° C. to about 380° C., and in some embodiments, from about 330° C. to about 370° C. The second liquid crystalline polymer(s) may contain aromatic dicarboxylic acid repeating units derived from one or more aromatic dicarboxylic acids; (ii) aromatic diol repeating units derived from one or more aromatic diols, and (iii) aromatic hydroxycarboxylic acid repeating units derived from one or more aromatic hydroxycarboxylic acids, such as described in more detail above.

The relative amounts of the monomeric constituents of the second liquid crystalline polymer(s) can be selectively controlled to help achieve the desired properties. In one embodiment, for instance, the second liquid crystalline polymer(s) may contain repeating units derived from TA and/or IA in an amount of from about 2 mol. % to about 30 mol. %, in some embodiments from about 3 mol. % to about 25 mol. %, and in some embodiments, from about 4 mol. % to about 22 mol. %. In contrast to the first liquid crystalline polymer(s), however, the second liquid crystalline polymer(s) are typically free of repeating units derived from NDA, or at the very least, contain repeating units derived from NDA in a relatively small amount, such as about 0.5 mol. % or less, in some embodiments about 0.3 mol. % or less, and in some embodiments, from 0 mol. % to about 0.2 mol. %. The second liquid crystalline polymer(s) may also contain repeating units derived from one or more aromatic diols. Typically, the aromatic diol repeating units in the first liquid crystalline polymer(s) are present in a greater amount than the second liquid crystalline polymer(s) such that the ratio of the aromatic diol repeating units of the first liquid crystalline polymer(s) to the aromatic diol repeating units of the second liquid crystalline polymer(s) is selectively controlled to be within a range of from about 1 to about 8, in some embodiments, from about 1.1 to about 5, and in some embodiments, from about 1.2 to about 4. For example, in total, HQ and/or BP may constitute from about 1 mol. % to about 30 mol. %., in some embodiments from about 2 mol. % to about 25 mol. %, and in some embodiments, from about 5 mol. % to about 20 mol. % of the second liquid crystalline polymer(s).

The second crystalline polymer(s) may also contain repeating units derived from HBA and/or HNA, which may, in total, constitute from about 30 mol. % to about 80 mol. %, and in some embodiments from about 35 mol. % to about 75 mol. %, and in some embodiments, from about 40 mol. % to about 70 mol. %. When employed, the molar ratio of HBA to HNA may be selectively controlled within a specific range to help achieve the desired properties, such as from about 2 to about 20, in some embodiments from about 4 to about 18, and in some embodiments, from about 5 to about 15. Likewise, the total amount of NDA, TA, and IA may be equimolar or in molar excess relative to the total amount of HQ and BP to help achieve the desired properties. In other words, the ratio of the moles of NDA, TA, and/or IA to the moles of HQ and/or BQ may be about 1 or more, in some embodiments from about 1 to about 2, and in some embodiments, from about 1.1 to about 1.6. Other monomer components may also be employed in the second liquid crystalline polymer(s), such as those described above. In one embodiment, for example, the second liquid crystalline polymer(s) may contain repeating units derived from APAP in an amount from about 0.1 mol. % to about 20 mol. %., in some embodiments from about 0.5 mol. % to about 15 mol. %, and in some embodiments, from about 1 mol. % to about 10 mol. % of the polymer(s).

### C. Other Polymers

In certain embodiments, the polymer matrix is formed entirely from the classes of polymers noted above—i.e., the first liquid crystalline polymer(s) and second crystalline polymer(s). Of course, additional polymers, such as liquid crystalline polymers, may also be employed in the polymer matrix if desired. In one particular embodiment, for instance, the polymer matrix may contain one or more third liquid crystalline polymers, typically in an amount from about 1 wt. % to about 35 wt. %, in some embodiments from about 2 wt. % to about 30 wt. %, and in some embodiments, from about 5 wt. % to about 25 wt. % of the polymer matrix and from about 1 wt. % to about 25 wt. %, in some embodiments from about 2 wt. % to about 20 wt. %, and in some embodiments, from about 5 wt. % to about 15 wt. % of the polymer composition. The third liquid crystalline polymer(s) may have a melting temperature below the first and second liquid crystalline polymers. For example, the third liquid crystalline polymer(s) may having a melting temperature of about 250° C. to about 350° C., in some embodiments from about 260° C. to about 340° C., and in some embodiments, from about 280° C. to about 320° C.

The third liquid crystalline polymer(s) may contain aromatic hydroxycarboxylic acid repeating units derived from one or more aromatic hydroxycarboxylic acids such as described in more detail above. The third crystalline polymer(s) may, for example, contain repeating units derived from HBA and/or HNA. In certain embodiments, the polymer may be formed entirely from such repeating units. For example, the repeating units derived from HBA may constitute from about 40 mol. % to about 90 mol. %, and in some embodiments from about 50 mol. % to about 85 mol. %, and in some embodiments, from about 60 mol. % to about 80 mol. % of the third liquid crystalline polymer(s) and the repeating units derived from HNA may constitute from about 10 mol. % to about 60 mol. %, and in some embodiments from about 15 mol. % to about 50 mol. %, and in some embodiments, from about 20 mol. % to about 40 mol. % of the third liquid crystalline polymer(s). The molar ratio of HBA to HNA may likewise be selectively controlled within a specific range to help achieve the desired properties, such as from about 1 to about 10, in some embodiments from about 1.5 to about 8, and in some embodiments, from about 2 to about 5. In contrast to the first and second liquid crystalline polymers, the third liquid crystalline polymer(s) are typically free of repeating units derived from NDA, TA, IA, BP, and/or HQ, or at the very least, contain such repeating units in a relatively small amount, such as about 10 mol. % or less, in some embodiments about 5 mol. % or less, and in some embodiments, from 0 mol. % to about 2 mol. %.

Regardless of the particular constituents, the liquid crystalline polymers (e.g., first, second, and/or third liquid crystalline polymers) may be prepared by initially introducing the aromatic monomer(s) used to form the ester repeating units (e.g., aromatic hydroxycarboxylic acid, aromatic dicarboxylic acid, etc.) and/or other repeating units (e.g., aromatic diol, aromatic amide, aromatic amine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation. In addition to the monomers and optional acetylating agents, other components may also be included within the reaction mixture to help facilitate polymerization. For instance, a catalyst may be optionally employed, such as metal salt catalysts (e.g., magnesium acetate, tin (I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 200° C. to about 400° C. For instance, one suitable technique for forming a liquid crystalline polymer may include charging precursor monomers and acetic anhydride into the reactor, heating the mixture to a temperature of from about 90° C. to about 150° C. to acetylize a hydroxyl group of the monomers (e.g., forming acetoxy), and then increasing the temperature to from about 200° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Generally speaking, the molten polymer is discharged from the reactor at a point in which the desired melt viscosity is achieved. As is known in the art, this may be correlated to the torque of the agitator. For example, after the torque of the agitator reaches a predetermined value, nitrogen may be introduced into the reactor so as to convert reduced pressure conditions to pressurized conditions via atmospheric pressure, thereby discharging the resultant polymer from the reactor, typically through an extrusion orifice fitted with a die of desired configuration, cooled, and collected. Commonly, the melt is discharged through a perforated die to form strands that are taken up in a water bath, pelletized and dried.

Although not always required or desired, the melt polymerized polymer may also be subjected to a subsequent solid-state polymerization method to further increase its molecular weight and achieve the desired melt viscosity. Solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of from about 200° C. to about 400° C. The polymerization time will of course vary based on the temperature and target molecular weight. In most cases, however, the solid-state polymerization time will be from about 2 to about 12 hours, and in some embodiments, from about 4 to about 10 hours.

### II. Melt Blending

The liquid crystalline polymers may be melt processed or blended together to form the polymer matrix. The components may be supplied separately or in combination to an extruder that includes at least one screw rotatably mounted and received within a barrel (e.g., cylindrical barrel) and may define a feed section and a melting section located downstream from the feed section along the length of the screw. The extruder may be a single screw or twin screw extruder. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

Regardless of the particular melt blending conditions, one of the advantages of the present invention is that selective control over the particular nature of the liquid crystalline polymers can allow them to be readily blended without the mechanism of transesterification leading to a substantial degradation in properties. A primary benefit of this result is that the liquid crystalline polymers do not need to be “virgin” polymers, but instead can be derived from scrap material that is generated during the polymerization process other commercial melt compounding processes. For example, during commercial polymerization and/or melt compounding processes, certain portions of the polymer may end up as scrap material either in the form of waste, rejected articles, or in the sprues and runners in the molding process.

Typically, however, at least a substantial portion of the scrap material is derived from polymer that is collected during pelletization (e.g., discharge from reactor, cutting, classification, etc.). Once collected, the scrap polymer may be used as is or alternatively reformed into pellets for melt compounding. In one embodiment, for example, pellets may be formed by a method that includes initially grinding the collected scrap polymer using known grinding equipment (wet or dry), such as jaw crusher, gyratory crusher, cone crusher, roll crusher, impact crusher, hammer crusher, cracking cutter, rod mill, ball mill, vibration rod mill, vibration ball mill, pan mill, roller mill, impact mill, discoid mill, stirring grinding mill, fluid energy mill, jet mill, etc. Jet milling, for instance, typically involves the use of a shear or pulverizing machine in which the polymer is accelerated by gas flows and pulverized by collision. Any type of jet mill design may be employed, such as double counterflow (opposing jet) and spiral (pancake) fluid energy mills. Gas and particle flow may simply be in a spiral fashion, or more intricate in flow pattern, but essentially particles collide against each other or against a collision surface. In certain embodiments, it may be desired to mill the polymer in the presence of a cryogenic fluid (e.g., dry ice, liquid carbon dioxide, liquid argon, liquid nitrogen, etc.) to produce a low-temperature environment in the system. The low-temperature environment chills the polymer below its glass transition point to facilitate grinding in a mill that applies impact or shear, such as a jet-mill. Regardless of the technique employed, the ground scrap particles may have any desired mean particle size, but it is typically from about 0.1 to about 250 micrometers, in some embodiments from about 0.2 to about 150 micrometers, and in some embodiments, from about 1 to about 100 micrometers, such as determined by optical microscopy. The scrap particles may then be re-pelletized into thermoplastic resin pellets as is known in the art. For example, the scrap particles may be heated into the form of a molten polymer, which is then passed through a die provided at a discharge port and extruded into strands. The strands may be cooled through a water bath, cooled, and then cut into the shape of pellets after solidification. One example of a suitable pelletizing apparatus for such purposes is an “underwater melt cutter”, which is described in more detail in U.S. Pat. No. 7,658,874 to Jackson, et al. and U.S. Patent Publication No. 2010/0102467 to Waggoner, et al., which are incorporated herein in their entirety by reference thereto. The pellets may then be dried (e.g., in an oven) prior to being combined with other polymers and/or additives.

Thus, in certain embodiments of the present invention, the first liquid crystalline polymer(s), the second liquid crystalline polymer(s), and/or the third liquid crystalline polymer(s) may be derived from the scrap polymer in the manner described above. That is, such polymers may be derived entirely or at least in substantial portion from a process that includes collecting the scrap material (recycled polymers), grinding the scrap material into particles, and then re-pelletizing the particles for subsequent melt compounding with other polymers and/or additives. In one embodiment, for example, the polymer matrix may in some cases be formed entirely from scrap material. In other embodiments, at least a portion of the polymer matrix may be formed from scrap material, such as about 10 wt. % or more, in some embodiments from about 20 wt. % to about 80 wt. %, and in some embodiments, from about 30 wt. % to about 70 wt. % of the polymer matrix.

### III. Fillers

In certain embodiments, the polymer composition may contain only the polymer matrix. Of course, in addition to the polymer matrix itself, it should also be understood that one or more fillers may also be incorporated into the polymer matrix during melt blending as is well known in the art. When employed, such filler(s) typically constitute from about 1 wt. % to about 70 wt. %, in some embodiments from about 10 wt. % to about 60 wt. %, and in some embodiments, from about 20 wt. % to about 55 wt. % of the polymer composition, while the polymer matrix may likewise constitute from about 30 wt. % to about 99 wt. %, in some embodiments from about 40 wt. % to about 90 wt. %, and in some embodiments, from about 45 wt. % to about 80 wt. % of the polymer composition.

In one embodiment, for example, reinforcing fibers may also be employed in the polymer composition, such as in an amount of from about 5 wt. % to about 50 wt. %, in some embodiments from about 8 wt. % to about 40 wt. %, and in some embodiments, from about 10 wt. % to about 35 wt. % of the polymer composition. Examples of such fibers may include, for instance, polymer fibers, metal fibers, carbonaceous fibers (e.g., graphite, carbide, etc.), inorganic fibers, etc., as well as combinations thereof. Inorganic fibers may be particularly suitable, such as those that are derived from glass; and so forth. Glass fibers may be particularly suitable for use in the present invention, such as those formed from E-glass, A-glass, C-glass, D-glass, AR-glass, R-glass, S1-glass, S2-glass, etc., as well as mixtures thereof. If desired, the reinforcing fibers may be provided with a sizing agent or other coating as is known in the art. The average diameter of the fibers may be from about 1 to about 50 micrometers, in some embodiments from about 5 to about 45 micrometers, and in some embodiments, from about 10 to about 35 micrometers, such as determined through known optical microscopy techniques. The fibers may be endless or chopped fibers, such as those having a length of from about 1 to about 15 millimeters, and in some embodiments, from about 2 to about 6 millimeters.

In addition to reinforcing fibers, the polymer composition may also contain a granular particulate filler that is distributed within the polymer matrix, such as in an amount of from about 5 wt. % to about 50 wt. %, in some embodiments from about 8 wt. % to about 40 wt. %, and in some embodiments, from about 10 wt. % to about 35 wt. % of the polymer composition. If desired, the particles may also have a high specific surface area, such as from about 1 square meters per gram (m²/g) to about 50 m²/g, in some embodiments from about 1.5 m²/g to about 25 m²/g, and in some embodiments, from about 2 m²/g to about 15 m²/g. Surface area may be determined by the physical gas adsorption (BET) method (nitrogen as the adsorption gas) in accordance with DIN 66131:1993. The moisture content may also be relatively low, such as about 5% or less, in some embodiments about 3% or less, and in some embodiments, from about 0.1 to about 1% as determined in accordance with ISO 787-2:1981 at a temperature of 105° C. Suitable granular particles may include, for instance, those formed from an inorganic material, such as barium sulfate, calcium sulfate, calcium carbonate, talc, etc. In one embodiment, for instance, the granular particulate filler may include talc particles. When employed, the median diameter of the talc particles may, for instance, range from about 3 to about 15 micrometers, in some embodiments from about 4 to about 12 micrometers, and in some embodiments, from about 5 to about 10 micrometers, such as determined using laser diffraction techniques in accordance with ISO 13320:2020 (e.g., with a Horiba LA-960 particle size distribution analyzer) and/or by sedimentation analysis (e.g., Sedigraph 5120).

In addition to granular filler particles (e.g., talc, barium sulfate, etc.), such as described above, other types of mineral fillers may also be employed, such as in an amount of from about 1 wt. % to about 40 wt. %, in some embodiments from about 2 wt. % to about 35 wt. %, and in some embodiments, from about 5 wt. % to about 30 wt. % of the polymer composition. Suitable non-granular mineral fillers may include, for instance, flaked-shaped mineral particles, mineral fibers (e.g., wollastonite fibers), etc. Flaked-shaped mineral particles, for example, may be employed that have a relatively high aspect ratio (e.g., average diameter divided by average thickness), such as about 4 or more, in some embodiments about 8 or more, and in some embodiments, from about 10 to about 500. In such embodiments, the average diameter of the particles may, for example, range from about 5 micrometers to about 200 micrometers, in some embodiments from about 8 micrometers to about 150 micrometers, and in some embodiments, from about 10 micrometers to about 100 micrometers. The average thickness may likewise be about 2 micrometers or less, in some embodiments from about 5 nanometers to about 1 micrometer, and in some embodiments, from about 20 nanometers to about 500 nanometers such as determined using laser diffraction techniques in accordance with ISO 13320:2020 (e.g., with a Horiba LA-960 particle size distribution analyzer). Suitable flaked-shaped mineral particles may be formed from a natural and/or synthetic silicate mineral, such as mica, halloysite, kaolinite, illite, montmorillonite, vermiculite, palygorskite, pyrophyllite, calcium silicate, aluminum silicate, wollastonite, etc. Mica is particularly suitable. Any form of mica may generally be employed, including, for instance, muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc. Muscovite-based mica is particularly suitable for use in the polymer composition.

A wide variety of additional additives can also be included in the polymer composition, such as impact modifiers, lubricants, pigments (e.g., carbon black), antioxidants, stabilizers, surfactants, waxes, flame retardants, nucleating agents (e.g., boron nitride), electrically conductive fillers, laser direct additives, and other materials added to enhance properties and processability. In one embodiment, for example, the polymer composition may be “laser activatable” in the sense that it contains a laser activatable additive that can be activated by a laser direct structuring (“LDS”) process. In such a process, the additive is exposed to a laser that causes the release of metals. The laser thus draws the pattern of conductive elements onto the part and leaves behind a roughened surface containing embedded metal particles. These particles act as nuclei for the crystal growth during a subsequent plating process (e.g., copper plating, gold plating, nickel plating, silver plating, zinc plating, tin plating, etc.). When employed, laser activatable additives typically constitute from about 0.5 wt. % to about 20 wt. %, in some embodiments from about 1 wt. % to about 15 wt. %, in some embodiments from about 2 wt. % to about 10 wt. %, and in some embodiments, from about 4 wt. % to about 7 wt. % of the polymer composition. The laser activatable additive may include spinel crystals, which may include two or more metal oxide cluster configurations within a definable crystal formation. For example, the overall crystal formation may have the following general formula:

AB₂O₄
wherein,
A is a metal cation having a valance of 2, such as cadmium, chromium, manganese, nickel, zinc, copper, cobalt, iron, magnesium, tin, titanium, etc., as well as combinations thereof; and
B is a metal cation having a valance of 3, such as chromium, iron, aluminum, nickel, manganese, tin, etc., as well as combinations thereof.

Typically, A in the formula above provides the primary cation component of a first metal oxide cluster and B provides the primary cation component of a second metal oxide cluster. These oxide clusters may have the same or different structures. In one embodiment, for example, the first metal oxide cluster has a tetrahedral structure and the second metal oxide cluster has an octahedral cluster. Regardless, the clusters may together provide a singular identifiable crystal type structure having heightened susceptibility to electromagnetic radiation. Examples of suitable spinel crystals include, for instance, MgAl₂O₄, ZnAl₂O₄, FeAl₂O₄, CuFe₂O₄, CuCr₂O₄, MnFe₂O₄, NiFe₂O₄, TiFe₂O₄, FeCr₂O₄, MgCr₂O₄, etc. Copper chromium oxide (CuCr₂O₄) is particularly suitable for use in the present invention and is available from Shepherd Color Co. under the designations 1G or LD 14 (Shepherd Color Co.).

### IV. Products

Generally speaking, the polymer composition is well suited for use in a wide variety of products, and particularly electronic components, such as electrical connectors, camera modules, antenna modules, etc. Examples of products that may contain such electronic components (e.g., connector, camera module, etc.) may include, for instance, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, camera modules, integrated circuits (e.g., SIM cards), housings for electronic devices, electrical controls, circuit breakers, switches, power electronics, printer parts, etc.

In one embodiment, for example, the polymer composition may be employed in a molded interconnect device. For example, the device may contain a substrate containing the polymer composition of the present invention and one one or more conductive elements plated thereon. The substrate may be formed using a variety of different molding techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, insert molding, pin-insert molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

The conductive elements may be deposited on the substrate using any of a variety of known plating techniques, such as laser direct structuring, electrolytic plating, electroless plating, digital printing, aerosol jet printing, and so forth. When containing a laser activatable additive, for instance, activation with a laser may cause a physio-chemical reaction in which the spinel crystals are cracked open to release metal atoms. These metal atoms can act as a nuclei for metallization (e.g., reductive copper coating). The laser also creates a microscopically irregular surface and ablates the polymer matrix, creating numerous microscopic pits and undercuts in which the copper can be anchored during metallization. The conductive elements may contain one or more of a variety of conductive materials, such as a metal, e.g., gold, silver, nickel, aluminum, copper, as well as mixture or alloys thereof. In one embodiment, for instance, the conductive elements may include copper and/or nickel (e.g., pure or alloys thereof). If desired, a seed layer may initially be formed on the substrate to facilitate the plating process. The method for forming the desired interconnect pattern may vary as is known to those killed in the art. For example, in certain cases, a pattern may initially be formed on the surface of the substrate based on the desired circuit interconnect pattern.

The molded interconnect device may be particularly suitable for use in an antenna module. In such embodiments, the plated conductive elements may be antenna elements (e.g., antenna resonating elements). The conductive elements can form antennas of a variety of different types, such as antennae with resonating elements that are formed from patch antenna elements, inverted-F antenna elements, closed and open slot antenna elements, loop antenna elements, monopoles, dipoles, planar inverted-F antenna elements, hybrids of these designs, etc. In one particular embodiment, for example, the antenna module may contain a shield member that is configured to cover a communication circuit and a dielectric on which is disposed one or more antenna elements. The shield member may contain a substrate on which a metal coating is plated. If desired, the dielectric and/or the substrate of the shield member may contain the polymer composition of the present invention. In certain embodiments, an interconnect member may also be employed in the antenna module that is electrically connected with the communication circuit and the antenna element(s). The interconnect member may likewise contain a substrate on which a metal coating is plated. If desired, the substrate of the interconnect member may contain the polymer composition of the present invention.

The present invention may be better understood with reference to the following examples and test methods.

### Test Methods

Melt Viscosity: The melt viscosity (Pa-s) may be determined in accordance with ISO 11443:2021 at a shear rate of 400 s⁻¹ or 1,000 s⁻¹ and temperature 15° C. above the melting temperature (e.g., about 325° C.) using a Dynisco LCR7001 capillary rheometer. The rheometer orifice (die) may have a diameter of 1 mm, length of 20 mm, L/D ratio of 20.1, and an entrance angle of 180°. The diameter of the barrel may be 9.55 mm+0.005 mm and the length of the rod may be 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO 11357-3:2018. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO 75-2:2013 (technically equivalent to ASTM D648). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO 527:2019 (technically equivalent to ASTM D638). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO 178:2019 (technically equivalent to ASTM D790). This test may be performed on a 64 mm support span. Tests may be run on the center portions of uncut ISO 3167 multi-purpose bars. The testing temperature may be 23° C. and the testing speed may be 2 mm/min.

Charpy Impact Strength: Charpy properties may be tested according to ISO 179-1:2010 (technically equivalent to ASTM D256-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Rockwell Hardness: Rockwell hardness is a measure of the indentation resistance of a material and may be determined in accordance with ASTM D785-08 (2015) (Scale M). Testing is performed by first forcing a steel ball indentor into the surface of a material using a specified minor load. The load is then increased to a specified major load and decreased back to the original minor load. The Rockwell hardness is a measure of the net increase in depth of the indentor, and is calculated by subtracting the penetration divided by the scale division from 130.

Blister-Free Temperature: To test blister resistance, a 127×12.7×0.8 mm test bar may be molded at 5° C. to 10° C. higher than the melting temperature of the polymer resin, as determined by DSC. Ten (10) bars are then placed through a heating chamber of a reflow oven at a predetermined temperature profile, subsequently removed, cooled to ambient conditions, and then inspected for blisters (i.e., surface deformations) that may have formed. The predetermined temperature profile begins at 250° C. and is increased at 10° C. increments until a blister is observed on one or more of the test bars. The highest temperature at which all ten (10) bars exhibit no observable blisters is identified as the “blister free temperature” for a tested material.

Flame Retardancy: The flame retarding efficacy may be determined according to the UL 94 Vertical Burn Test procedure of the “Tests for Flammability of Plastic Materials for Parts in Devices and Appliances” (edition date of Feb. 28, 2023), which is now harmonized with IEC 60707, 60695-11-10 and 60695-11-20 and ISO 9772 and 9773. In the test, two sets of five samples (ten total) are employed that have a length of 125 mm, width of 13 mm, and a thickness in the desired range (e.g., 0.8 mm, 0.4 mm, or 0.2 mm). The two sets of samples may be conditioned before and after aging. For unaged testing, each thickness is tested after conditioning for 48 hours at 23° C. and 50% relative humidity. For aged testing, five (5) samples of each thickness are tested after conditioning for 168 hours at a temperature of 70° C. and then cooled in a dessicator for at least 4 hours at room temperature. To initiate testing, the sample holder may be positioned so that the sample is held at least 425 mm above a working surface. Cotton batting (e.g., less than 6 mm in thickness) may be placed directly below the clamp to ensure that an area of 50 mm×50 mm is covered. The top 6 mm of the specimen may be placed vertically in the clamp and the holder may be adjusted so that the bottom edge of the specimen is 300±10 mm above the cotton batting. Once in position, the flame may be applied for ten (10) seconds and then removed until flaming stops, at which time the flame may be reapplied for another ten (10) seconds and then removed. If dripping is present, it should fall onto the cotton batting underneath the specimen. When the flaming burn stops, the time is recorded as “t1” and the burner is then reapplied. The time at which flaming burn ends is recorded as “t2.” The time at which the glowing burn ends is recorded as “t3.” The results are then compared to the UL94 flame ratings based on the criteria provided in the table below.

| | | | | # Drips of | | Combustion |
|---|---|---|---|---|---|---|
| | | | | Burning | # Drips of | Up to |
| | Burning Time | | | Specimen | Burning | Holding |
| | of Individual | Total | Burning and | (without | Specimen | Clamp |
| | Specimen (after | Flame | Afterglow | ignition of | (ignition | (specimens |
| | 1^{st} and 2^{nd} flame | Time(s) | Times | cotton | of cotton | completely |
| Rating | applications) (s) | (t1 + t2) | (t2 + t3) | batting) | batting) | burned) |
| V-2 | ≤30 | ≤250 | ≤60 | ≥0 | ≥0 | No |
| V-1 | ≤30 | ≤250 | ≤60 | ≥0 | 0 | No |
| V-0 | ≤10 | ≤50 | ≤30 | ≥0 | 0 | No |

### Examples 1-7

Examples 1-7 are formed from various percentages of a first liquid crystalline polymer (“LCP 1”), second liquid crystalline polymer (“LCP 2”), third liquid crystalline polymer (“LCP 3”), glass fibers, talc, and a laser direct structured concentrate (“LDS Concentrate”) containing 30 wt. % copper chromite black spinel crystals and 70 wt. % of a liquid crystalline polymer (“LCP 2a”). LCP 1 is formed from about 61.5% HBA, 13.5% TA, 9.6% BP, 9.6% HQ, and 5.8% NDA and has a melting temperature of about 335° C. LCP 2 is formed from about 60% HBA, 5% HNA, 12.5% BP, 17.5% TA, and 5% APAP and has a melting temperature of about 338° C. LCP 3 is formed from 73% HBA and 27% HNA and has a melting temperature of about 280° C. LCP1, LCP2, and LCP3 were each obtained from scrap material collected during the commercial pelletization process of each individual polymer. The scrap material was ground into particles (1-2 lbs. for 15 minutes), re-pelletized, and then dried at 275° C. for 4-6 hours prior to being melt blended with the glass fibers, talc, and LDS concentrate. LCP 2a had the same components as LCP 2 but was not derived from plant waste. The specific formulations are set forth in more detail below in Table 1.

TABLE 1
Formulation

| | | Ex. 1 | Ex. 2 | Ex. 3 | Ex. 4 | Ex. 5 | Ex. 6 | Ex. 7 |
|---|---|---|---|---|---|---|---|---|
| Polymer | LCP 1 | — | 21.0 | 12.0 | 4.0 | 12.6 | 16.2 | 12.6 |
| Matrix | LCP 2 | 42.0 | 21.0 | 30.0 | 38.0 | 16.8 | 17.4 | 21.0 |
| | LCP 3 | — | — | — | — | 12.6 | 8.4 | 8.4 |
| | LCP 2a | 15.4 | 15.4 | 15.4 | 15.4 | 15.4 | 15.4 | 15.4 |
| Fillers | Copper | 6.6 | 6.6 | 6.6 | 6.6 | 6.6 | 6.6 | 16.6 |
| | Chromite | | | | | | | |
| | Glass | 20 | 20 | 20 | 20 | 20 | 20 | 20 |
| | Fibers | | | | | | | |
| | Talc | 16 | 16 | 16 | 16 | 16 | 16 | 16 |

Samples 1-7 were tested for thermal, mechanical, and flammability. The results are set forth below in Tables 2-3.

TABLE 2
Thermal and Mechanical Properties

| | Ex. 1 | Ex. 2 | Ex. 3 | Ex. 4 | Ex. 5 | Ex. 6 | Ex. 7 |
|---|---|---|---|---|---|---|---|
| Melting Temperature | 334.5 | 331.3 | 329.8 | 332.7 | 324.1 | 325.5 | 296.3 |
| (° C., 1^{st} heat of DSC) | | | | | | | |
| Melt Viscosity at 1,000 s⁻¹ (Pa-s) | 45 | 50 | 44 | 43 | 42 | 46 | 45 |
| DTUL (1.8 MPa, ° C.) | 259 | 261 | 260 | 260 | 251 | 252 | 253 |
| Charpy Notched Strength (kJ/m²) | 11 | 11 | 11 | 11 | 11 | 11 | 11 |
| Charpy Unnotched Strength (kJ/m²) | 36.5 | 39 | 42 | 40 | 35 | 35 | 37 |
| Rockwell Hardness Value | 62 | 59 | 59 | 60 | 63 | 61 | 60 |
| Tensile Strength (MPa) | 138 | 138 | 138 | 138 | 140 | 142 | 141 |
| Tensile Modulus (MPa) | 15,366 | 15,273 | 15,052 | 15,520 | 15,886 | 15,986 | 15,811 |
| Tensile Elongation (%) | 1.72 | 1.69 | 1.78 | 1.7 | 1.71 | 1.77 | 1.69 |
| Flexural Strength (MPa) | 198 | 199 | 200 | 201 | 204 | 204 | 205 |
| Flexural Modulus (MPa) | 15,047 | 15,063 | 14,836 | 15,064 | 15,250 | 15,391 | 15,399 |
| Flexural Elongation (%) | 2.21 | 2.23 | 2.34 | 2.27 | 2.36 | 2.3 | 2.3 |

TABLE 3
Unaged Flammability at 0.8 mm

| | Ex. 1 | Ex. 2 | Ex. 3 | Ex. 4 | Ex. 5 | Ex. 6 | Ex. 7 |
|---|---|---|---|---|---|---|---|
| UL 94 Results | V-0 | V-0 | V-0 | V-0 | V-0 | V-0 | V-0 |
| # burnt over 10 sec | 0 | 0 | 0 | 0 | 0 | 0 | 0 |
| # drips without | 0 | 0 | 0 | 0 | 0 | 0 | 0 |
| ignition of cotton | | | | | | | |
| # drips with ignition | 0 | 0 | 0 | 0 | 0 | 0 | 0 |
| of cotton | | | | | | | |
| # burn to clamp | 0 | 0 | 0 | 0 | 0 | 0 | 0 |

### Examples 8-12

Examples 8-12 are formed from LCP 1, LCP 2, another type of a first liquid liquid crystalline polymer (“LCP 1b”), LDS Concentrate, talc, and glass fibers. LCP 1b is formed from about 42.8% HBA, 8.6% TA, 28.6% HQ, and 20% NDA and has a melting temperature of about 315° C. The specific formulations are set forth in more detail below in Table 4.

TABLE 4
Formulation

| | | Ex. 8 | Ex. 9 | Ex. 10 | Ex. 11 | Ex. 12 |
|---|---|---|---|---|---|---|
| Polymer | LCP 1 | — | — | — | — | 10 |
| Matrix | LCP 1b | — | 30 | 20 | 10 | 10 |
| | LCP 2 | 42 | 12 | 22 | 31 | 22 |
| | LCP 2a | 15.4 | 15.4 | 15.4 | 15.4 | 15.4 |
| Fillers | Copper | 6.6 | 6.6 | 6.6 | 6.6 | 6.6 |
| | Chromite | | | | | |
| | Glass | 20 | 20 | 20 | 20 | 20 |
| | Fibers | | | | | |
| | Talc | 16 | 16 | 16 | 16 | 16 |

Samples 8-12 were tested for thermal, mechanical, and flammability. The results are set forth below in Tables 5-6.

TABLE 5
Thermal and Mechanical Properties

| | Ex. 8 | Ex. 9 | Ex. 10 | Ex. 11 | Ex. 12 |
|---|---|---|---|---|---|
| Melting Temperature (° C., 1^{st} heat of DSC) | 333.6 | 316.4 | 315.1 | 321.6 | 323.3 |
| Melt Viscosity at 1,000 s⁻¹ (Pa-s) | 37.0 | 46.3 | 40.3 | 37.1 | 42.5 |
| DTUL (1.8 MPa, ° C.) | 261 | 255 | 253 | 255 | 254 |
| Charpy Notched Strength (kJ/m²) | 14 | 13 | 13 | 13 | 13 |
| Charpy Unnotched Strength (kJ/m²) | 35 | 32 | 31 | 34 | 37 |
| Rockwell Hardness Value | 59 | 59 | 57 | 58 | 58 |
| Tensile Strength (MPa) | 132 | 138 | 139 | 137 | 139 |
| Tensile Modulus (MPa) | 14,871 | 15,269 | 15,226 | 15,260 | 15,337 |
| Tensile Elongation (%) | 1.68 | 1.63 | 1.74 | 1.67 | 1.67 |
| Flexural Strength (MPa) | 197 | 203 | 200 | 202 | 201 |
| Flexural Modulus (MPa) | 14,919 | 15,091 | 15,036 | 14,948 | 14,824 |
| Flexural Elongation (%) | 2.15 | 2.13 | 2.14 | 2.23 | 2.24 |

TABLE 6
Unaged Flammability at 0.8 mm

| | Ex. 8 | Ex. 9 | Ex. 10 | Ex. 11 | Ex. 12 |
|---|---|---|---|---|---|
| UL 94 Results | V-0 | V-0 | V-0 | V-0 | V-0 |
| # burnt over 10 sec | 0 | 0 | 0 | 0 | 0 |
| # drips without ignition | 0 | 0 | 0 | 0 | 0 |
| of cotton | | | | | |
| # drips with ignition of | 0 | 0 | 0 | 0 | 0 |
| cotton | | | | | |
| # burn to clamp | 0 | 0 | 0 | 0 | 0 |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A polymer composition comprising a polymer matrix, wherein the polymer matrix comprises:
at least one first liquid crystalline polymer containing aromatic dicarboxylic acid repeating units derived from 2,6-naphthalenedicarboxylic acid and optionally terephthalic acid, isophthalic acid, or a combination thereof; aromatic diol repeating units derived from hydroquinone, 4,4′-biphenol, or a combination thereof; and aromatic hydroxycarboxylic acid repeating units derived from 4-hydroxybenzoic acid, 6-hydroxy-2-naphthoic acid, or a combination thereof, wherein the repeating units derived from 2,6-naphthalenedicarboxylic acid constitute from about 2 mol. % to about 30 mol. % of the first liquid crystalline polymer;
at least one second liquid crystalline polymer containing aromatic dicarboxylic acid repeating units derived from 2,6-naphthalenedicarboxylic acid, terephthalic acid, isophthalic acid, or a combination thereof; aromatic diol repeating units derived from hydroquinone, 4,4′-biphenol, or a combination thereof; and aromatic hydroxycarboxylic acid repeating units derived from 4-hydroxybenzoic acid, 6-hydroxy-2-naphthoic acid, or a combination thereof, wherein the repeating units derived from 2,6-naphthalenedicarboxylic acid constitute no more than about 0.5 mol. % of the second liquid crystalline polymer;
wherein the ratio of the aromatic diol repeating units of the first liquid crystalline polymer to the aromatic diol repeating units of the second liquid crystalline polymer is from about 1 to about 8.

2. The polymer composition of claim 1, wherein the first liquid crystalline polymer, the second liquid crystalline polymer, or a combination thereof are obtained from recycled scrap.

3. The polymer composition of claim 1, wherein the first liquid crystalline polymer constitutes from about 1 wt. % to about 50 wt. % of the polymer matrix and the second liquid crystalline polymer constitutes from about 50 wt. % to about 99 wt. % of the polymer matrix.

4. The polymer composition of claim 1, wherein the first liquid crystalline polymer contains repeating units derived from terephthalic acid and/or isophthalic acid in an amount of from about 1 mol. % to about 30 mol. %.

5. The polymer composition of claim 1, wherein the first liquid crystalline polymer contains repeating units derived from hydroquinone and/or 4,4′-biphenol in an amount of from about 5 mol. % to about 40 mol. %.

6. The polymer composition of claim 1, wherein the first liquid crystalline polymer contains repeating units derived from 4-hydroxybenzoic acid in an amount of from about 30 mol. % to about 80 mol. %.

7. The polymer composition of claim 1, wherein the second liquid crystalline polymer is free from aromatic dicarboxylic acid repeating units derived from 2,6-naphthalenedicarboxylic acid.

8. The polymer composition of claim 1, wherein the second liquid crystalline polymer contains repeating units derived from 6-hydroxy-2-naphthoic acid and/or 4-hydroxybenzoic acid in an amount of from about 30 mol. % to about 80 mol. %.

9. The polymer composition of claim 1, wherein the second liquid crystalline polymer contains repeating units derived from hydroquinone and/or 4,4′-biphenol in an amount of from about 1 mol. % to about 30 mol. %.

10. The polymer composition of claim 1, wherein the polymer matrix contains at least one third liquid crystalline polymer.

11. The polymer composition of claim 10, wherein the third liquid crystalline polymer is present in an amount of from about 1 wt. % to about 35 wt. % of the polymer matrix.

12. The polymer composition of claim 10, wherein the third liquid crystalline polymer contains repeating units derived from 4-hydroxybenzoic acid and 6-hydroxy-2-naphthoic acid.

13. The polymer composition of claim 12, wherein the third liquid crystalline polymer contains repeating units derived from 4-hydroxybenzoic acid in an amount of from about 40 mol. % to about 90 mol. % and 6-hydroxy-2-naphthoic acid in an amount of from about 10 mol. % to about 60 mol. %.

14. The polymer composition of claim 10, wherein the third liquid crystalline polymer is obtained from recycled scrap material.

15. The polymer composition of claim 1, wherein the polymer matrix exhibits a melting temperature of about 240° C. or more.

16. The polymer composition of claim 1, wherein the polymer composition exhibits a deflection temperature under load of about 150° C. or more.

17. The polymer composition of claim 1, wherein the polymer composition further contains a filler.

18. The polymer composition of claim 17, wherein the filler includes reinforcing fibers.

19. The polymer composition of claim 17, wherein the filler includes granular filler particles, flaked-shaped mineral particles, mineral fibers, or a combination thereof.

20. The polymer composition of claim 17, wherein the filler includes a laser activatable additive.
